(19) United States
(12) Patent Application Publication
(10) Pub. No.: US 2025/0378647 A1
(43) Pub. Date: Dec. 11, 2025

(54) VIRTUAL STYLIST

(71) Applicant: Penelope Elgort, Colts Neck, NJ (US)

(72) Inventor: Penelope Elgort, Colts Neck, NJ (US)

(21) Appl. No.: 19/227,319

(22) Filed: Jun. 3, 2025

Related U.S. Application Data
(60) Provisional application No. 63/656,131, filed on Jun. 5, 2024.

(51) Int. Cl. G06T 19/00; G06T 15/60; G06T 17/20; G06V 10/82; G06V 40/10; H04N 23/60

(52) U.S. Cl. CPC G06T 19/00; G06T 15/60; G06T 17/20; G06T 2200/24; G06T 2210/16; G06V 10/82; G06V 40/103; H04N 23/64

(57) ABSTRACT

An example operation may include at least one of receiving, via a user interface of a device, an activation input from a user to initiate a session, capturing, by a camera of the device, a scan of a body of the user, wherein the capturing comprises recording at least one image and/or at least one video of the user, processing the at least one image and/or video to generate a three- dimensional model of the user comprising measurements and contours of the body, retrieving, from a database, at least one clothing item associated with the user, the at least one clothing item comprising dimensional attributes and texture attributes, rendering, by a graphics processing unit, the at least one clothing item onto the three-dimensional model to generate a visual representation, wherein the rendering simulates draping behavior, movement, and light interaction of the at least one clothing item relative to the three-dimensional model, and displaying, on the user interface, an interactive visualization comprising the visual representation of the three-dimensional model with the at least one clothing item from multiple viewing angles.

### CROSS-REFERENCE TO RELATED APPLICATION

This application claims priority to U.S. provisional application Ser. No. 63,656,131, entitled “METHOD AND SYSTEM FOR SHOPPING ASSISTANCE”, filed on Jun. 5, 2024, the entire disclosure of which is incorporated by reference herein.

### BACKGROUND

With the rise of e-commerce, online clothing shopping has become increasingly popular. However, one significant drawback is the inability of customers to try on clothes before making a purchase. Traditional size charts and model images often fail to provide a satisfactory representation of how garments will fit and look on individual users. Furthermore, customers frequently struggle with creating cohesive outfits, choosing suitable color schemes and a clothing style, and managing their existing wardrobe efficiently.

### SUMMARY

One example embodiment provides an system that includes at least one of a computing device comprising a processor, a memory, a display, and a camera, a user interface executable on the computing device and configured to receive an activation input from a user to initiate a session, a body scanning module executable on the processor and configured to capture, via the camera, at least one image and/or at least one video of a body of the user and to generate a three- dimensional model of the user based on the at least one image and/or video, the three- dimensional model comprising measurements and contours of the body, a clothing retrieval module, configured to retrieve at least one clothing item associated with the user from a database, the at least one clothing item comprising dimensional attributes and texture attributes, and a rendering engine, comprising a graphics processing unit (GPU) configured to render the at least one clothing item onto the three-dimensional model to generate a visual representation simulating draping behavior, movement, and light interaction, wherein the user interface is further configured to display an interactive visualization comprising the visual representation of the three-dimensional model with the at least one clothing item from multiple viewing angles

Another example embodiment provides a method that includes at least one of receiving, via a user interface of a device, an activation input from a user to initiate a session, capturing, by a camera of the device, a scan of a body of the user, wherein the capturing comprises recording at least one image and/or at least one video of the user, processing the at least one image and/or video to generate a three-dimensional model of the user comprising measurements and contours of the body, retrieving, from a database, at least one clothing item associated with the user, the at least one clothing item comprising dimensional attributes and texture attributes, rendering, by a graphics processing unit, the at least one clothing item onto the three-dimensional model to generate a visual representation, wherein the rendering simulates draping behavior, movement, and light interaction of the at least one clothing item relative to the three-dimensional model, and displaying, on the user interface, an interactive visualization comprising the visual representation of the three-dimensional model with the at least one clothing item from multiple viewing angles.

A further example embodiment provides a computer readable storage medium comprising instructions, that when read by a processor, cause the processor to perform at least one of receiving, via a user interface of a device, an activation input from a user to initiate a session, capturing, by a camera of the device, a scan of a body of the user, wherein the capturing comprises recording at least one image and/or at least one video of the user, processing the at least one image and/or video to generate a three-dimensional model of the user comprising measurements and contours of the body, retrieving, from a database, at least one clothing item associated with the user, the at least one clothing item comprising dimensional attributes and texture attributes, rendering, by a graphics processing unit, the at least one clothing item onto the three-dimensional model to generate a visual representation, wherein the rendering simulates draping behavior, movement, and light interaction of the at least one clothing item relative to the three-dimensional model, and displaying, on the user interface, an interactive visualization comprising the visual representation of the three-dimensional model with the at least one clothing item from multiple viewing angles.

### BRIEF DESCRIPTION OF DRAWINGS

FIG. 1 is a system diagram illustrating an operating environment of a software service, according to examples and features of the instant solution.

FIG. 2A is a system diagram illustrating integration of an AI model into any decision point, according to the examples and features of the instant solution.

FIG. 2B is a diagram illustrating a process for developing an AI model that supports AI- assisted computer decision points, according to the examples and features of the instant solution.

FIG. 2C is a diagram illustrating a process for utilizing an AI model that supports AI- assisted computer decision points according to examples and features of the instant solution.

FIG. 2D is a system diagram illustrating a chatbot service that utilizes an AI model.

FIG. 3A is a system diagram illustrating an operating environment for a virtual stylist, according to examples and features of the instant solution.

FIG. 3B is another system diagram illustrating an operating environment for a virtual stylist, according to examples and features of the instant solution.

FIG. 3C is a process flow for a user experience, according to examples and features of the instant solution.

FIG. 4A is a flow diagram illustrating a method for a virtual stylist service, according to examples and features of the instant solution.

FIG. 4B is another flow diagram illustrating a method for a virtual stylist service, according to examples and features of the instant solution.

FIG. 5 is a system diagram illustrating a computing environment according to the instant solution's example features, structures, or characteristics.

### DETAILED DESCRIPTION

The instant solution relates to the field of virtual clothing visualization, personal styling, and wardrobe management systems. More specifically, it provides a technical approach for generating a three-dimensional (3D) body model of a person based on captured visual data and applying intelligent recommendation techniques to enhance the user's fashion experience. The system integrates multiple subsystems including a body scanning module, wardrobe scanning module, style recommendation engine, virtual try-on rendering engine, and a smart closet interface. Through the use of artificial intelligence, computer vision, and graphics rendering technologies, the system creates an interactive and personalized environment in which users may visualize outfits on a virtual replica of themselves, manage their wardrobe, and receive curated style suggestions based on their actual clothing inventory and preferences.

The body scanning process initiates with a camera setup and calibration phase that ensures optimal conditions for accurate visual data acquisition. During this phase, the system adjusts intrinsic camera settings, including focus, exposure, and white balance, to account for the ambient lighting and device-specific optical characteristics. The application interface guides the user to position themselves within a predefined capture frame, ensuring consistent body posture and visibility. Visual prompts and on-screen indicators assist the user in maintaining alignment, distance, and lighting uniformity throughout the scan. This calibration phase improves image clarity and dimensional consistency, forming a reliable foundation for subsequent anatomical landmark detection and three-dimensional model generation.

Conventional online shopping and wardrobe applications fail to provide real-time visualization of garment fit on individual body types and do not integrate with the user's existing clothing inventory. The instant solution addresses these limitations by creating a dynamic 3D model of the user using captured images or video, identifying body measurements, and generating an anatomically accurate mesh. The model is used in conjunction with wardrobe data to simulate garment fit and movement using physics-based rendering techniques. A smart closet module, including an embedded control interface, further supports organization and item retrieval. The system also connects to retail databases to identify wardrobe gaps and recommend compatible new clothing items, enhancing the accuracy and confidence of online purchases. Through this technical configuration, the instant solution enables a seamless integration between digital styling, physical wardrobe management, and e-commerce engagement.

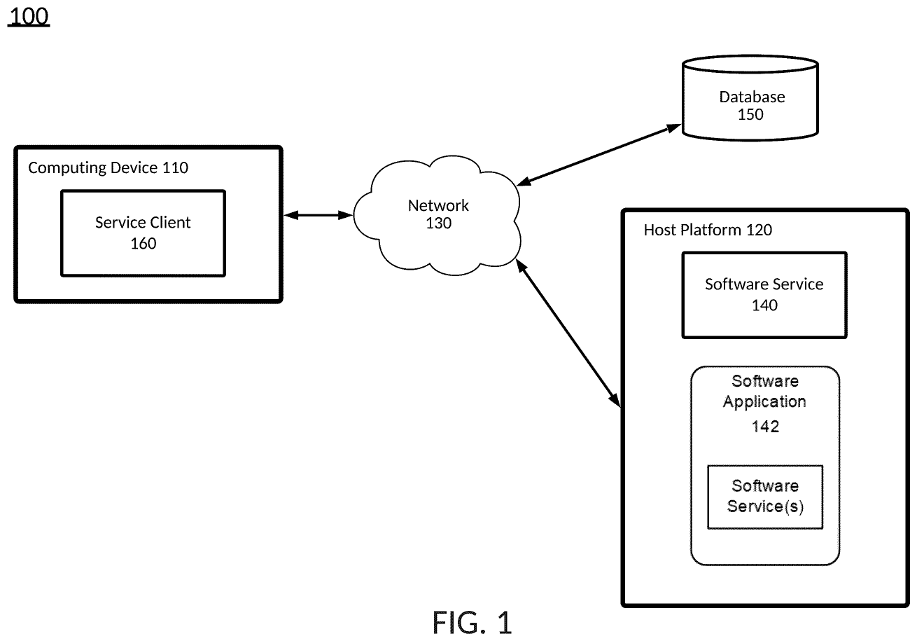

FIG. 1 is a system diagram illustrating an example operating environment of the instant solution. As shown, at least one computing device 110, and a host platform 120 communicate via a network 130. The host platform 120 may host a software service 140. The software service 140 may communicate with at least one database 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premises” while others are cloud-hosted. The network 130 is a computer network and may include at least one interconnected computer network. For example, network 130 may be or may include an Ethernet network, an asynchronous transfer mode (ATM) network, a wireless network, a telecommunications network or the like.

The software service 140 provides the service logic. It may provide at least one Application Programming Interface (API) for communicating with at least one service client 160. A “thick” user interface client that runs on a computing device 110 may utilize the APIs to communicate with the software service 140. Further, the software service 140 may provide hosted User Interfaces (UIs) that can be accessed through browser-based software on some computing devices 110.

The at least one service client 160 can enable service access for end users and may come in a variety of forms including, but not limited to, a mobile device application (“app”) or a web portal accessed via a browser on a computing device 110 such as a laptop or desktop computer.

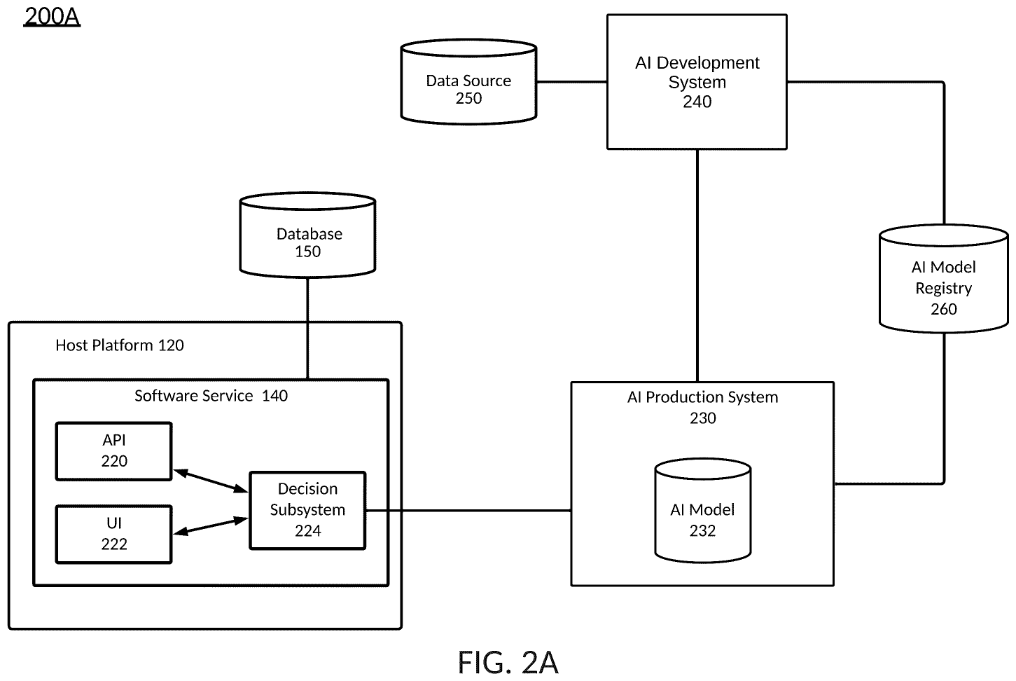

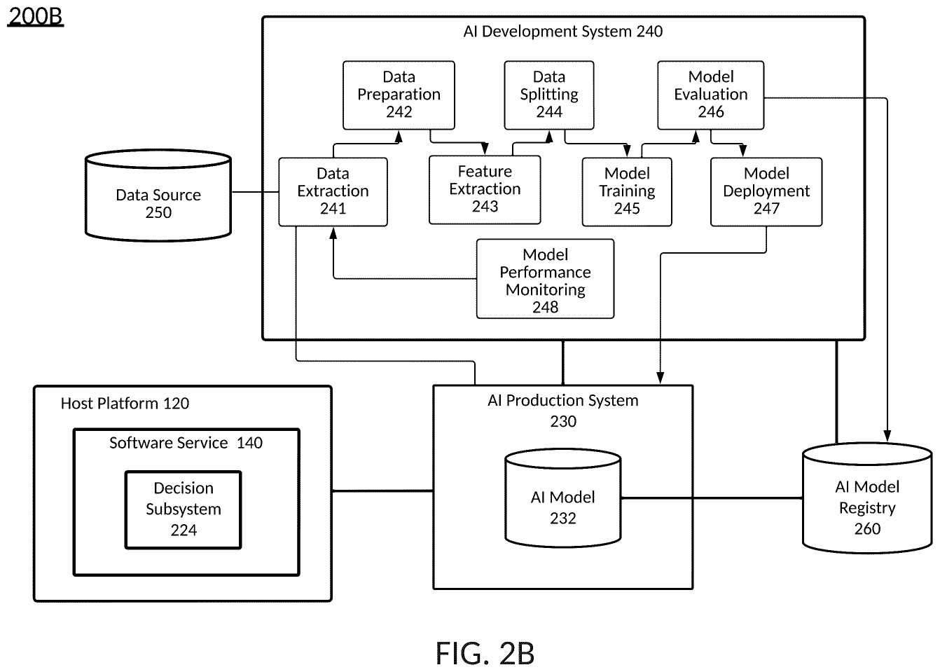

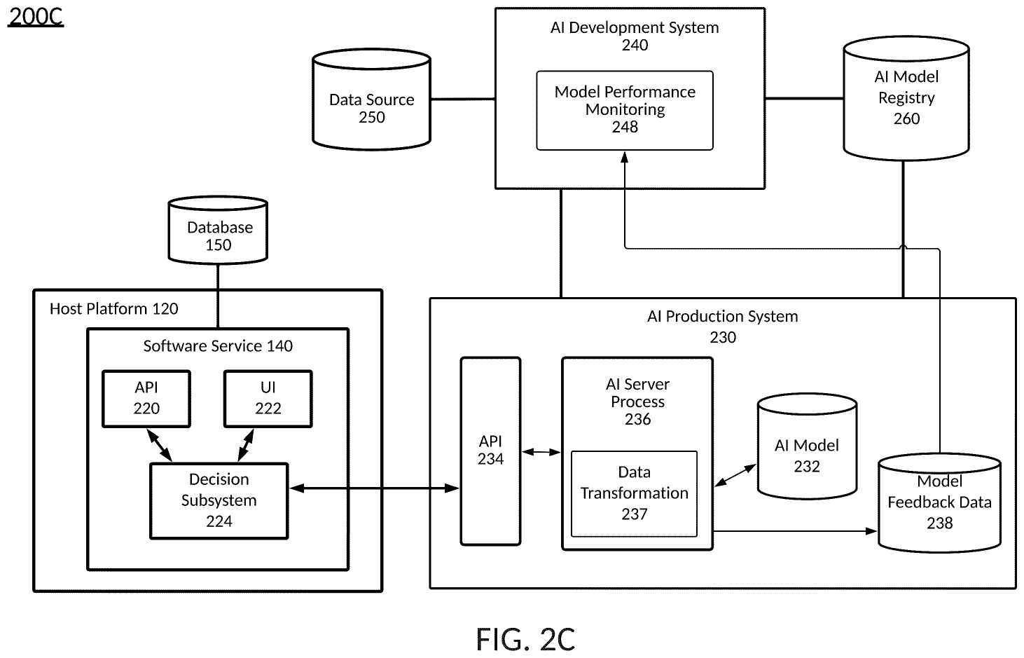

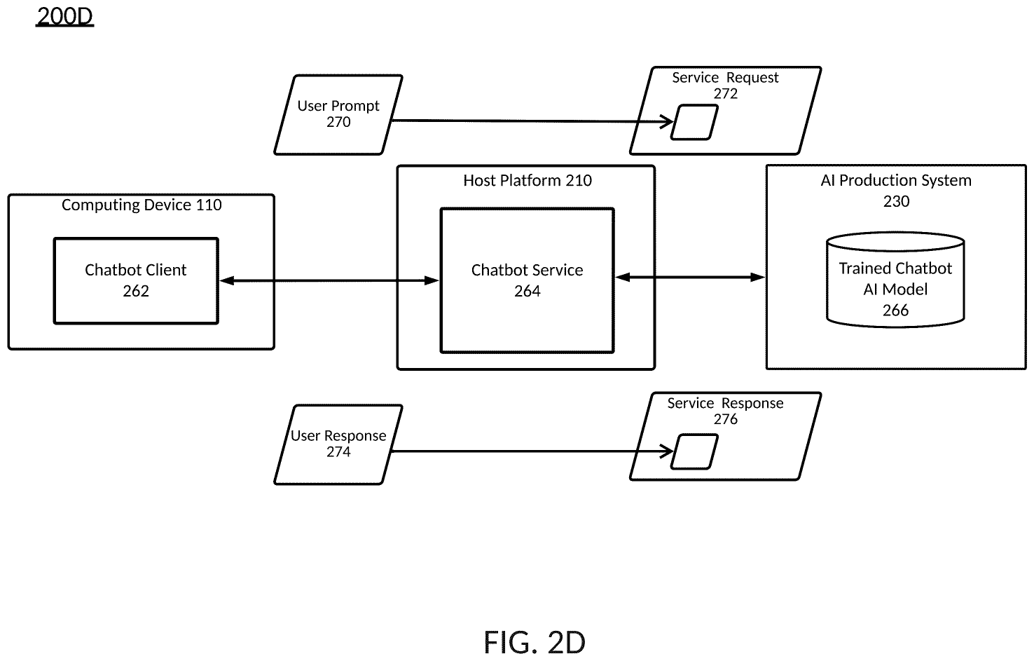

FIG. 2A illustrates an artificial intelligence (AI) network diagram 200A that supports AI- assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide at least one API 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 140 to assist in decision-making. In some examples and features of the instant solution, the software service 140 stores data included in API requests or data generated during processing the API requests into at least one database 150 (see FIGS. 1, 2A). In some examples and features of the instant solution, software service 140 is a chatbot service.

Software service 140 may provide at least one user interface (UI) 222, such as a server- side hosted graphical user interface (GUI). In some examples and features of the instant solution, the UIs 222 provided employ template-based frameworks, component-based frameworks, etc. In some examples and features of the instant solution, these UIs 222 send data to at least one decision subsystem 224 of the software service 140 to assist with decision-making. In some examples and features of the instant solution, the software service 140 stores data included in UI requests or data generated during processing the UI requests into at least one database 150.

Software service 140 may include at least one decision subsystem 224 that drive a decision-making process of the software service 140. In some examples and features of the instant solution, the decision subsystems 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes at least one AI model 232 that is executed to generate a response, such as, but not limited to, a prediction, a categorization, a UI prompt, etc. In some examples and features of the instant solution, the AI model 232 has been trained to provide chatbot responses. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real- world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node functionality. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI- assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

In one example, an AI development system 240 is configured to process input data and train a machine learning model 232. The system receives data from at least one data source 250, and optionally one or more AI Production Systems 230, which may undergo a sequence of preprocessing steps before being used for training a predictive model. The AI development system 240 extracts data related to one or more of the instant features from at least one data source 250 in the data extraction 241. This extracted data is then processed through data preparation 242 to normalize or filter relevant information. Feature extraction 243 follows, where meaningful features are identified to improve model performance. The dataset is then split 244 into training and validation subsets.

The AI Development System 240 (serving as a machine learning server) is directed to generate a predictive model based on machine learning of the data. The system initiates model training 245 using the prepared dataset. The AI development system 240 selects an appropriate machine learning algorithm and hyperparameters to optimize predictive accuracy. The trained model undergoes model evaluation 246 using validation data to assess performance. If the model meets predefined accuracy thresholds, it is deployed 247 to an AI production system 230 and registered in the AI model registry 260 for use in real-time decision-making.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

FIG. 2D is a system diagram illustrating a chatbot service that utilizes an AI model. Referring to FIG. 2D, a computing device 110 (see FIGS. 1, 2D) may host a chatbot client 262 which interworks with a chatbot service 264 executing on a host platform 120 (see FIGS. 1, 2D). Further, the chatbot service 264 utilizes a trained chatbot AI model 266 that is resident on an AI production system 230 (see FIGS. 2A-2D). In some examples and features of the instant solution, the chatbot client 262 is an example of a service client 160, depicted in FIG. 1. In some examples and features of the instant solution, the chatbot service 264 is an example of software service 140 (see FIG. 2A) which includes an API 220 (see FIG. 2A), a UI 222 (see FIG. 2A) and at least one decision subsystem 224 (see FIG. 2A). In some examples and features of the instant solution, the trained chatbot AI model 266 is an example of AI model 232 (see FIGS. 2A-2C) which is hosted on an AI production system 230 (see FIGS. 2A-2D). In some examples and: features of the instant solution, the AI production system 230 (see FIG. 2D) includes the internal architectural elements depicted in FIG. 2C.

The chatbot client 262 accepts and captures a user prompt 270 which it sends to the chatbot service 264. Upon receiving the user prompt 270, the chatbot service 264 builds a service request 272 that includes the user prompt 270. In some examples and features of the instant solution, the service request 272 may include a target AI model identifier, such as an identifier to a trained chatbot AI model 266. Once built, the service request 272 is delivered to the AI production system 230 (see FIGS. 2A-2D). Upon receipt of the service request 272, the AI production system 230 determines the target AI model, such as the trained chatbot AI model 266, and extracts the user prompt 270. In some examples and features of the instant solution, the AI production system transforms the user prompt 270 using Natural Language Understanding (NLU) or Natural Language Processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. In some examples and features of the instant solution, the trained chatbot AI model 266 utilizes neural networks or Natural Language Generation (NLG) techniques in order to determine the appropriate user response 274.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it.

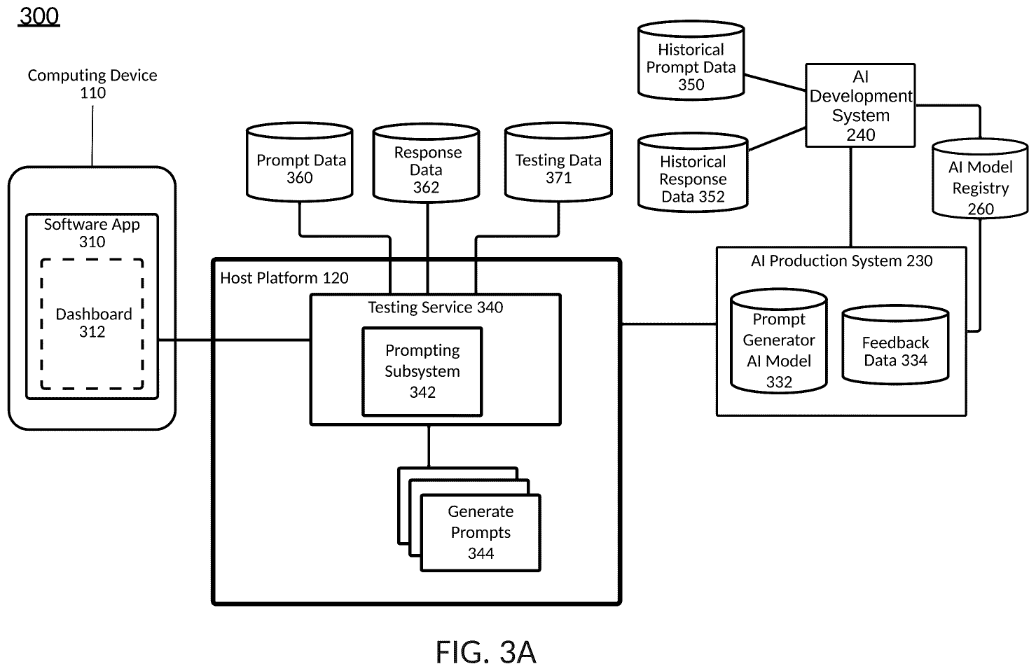

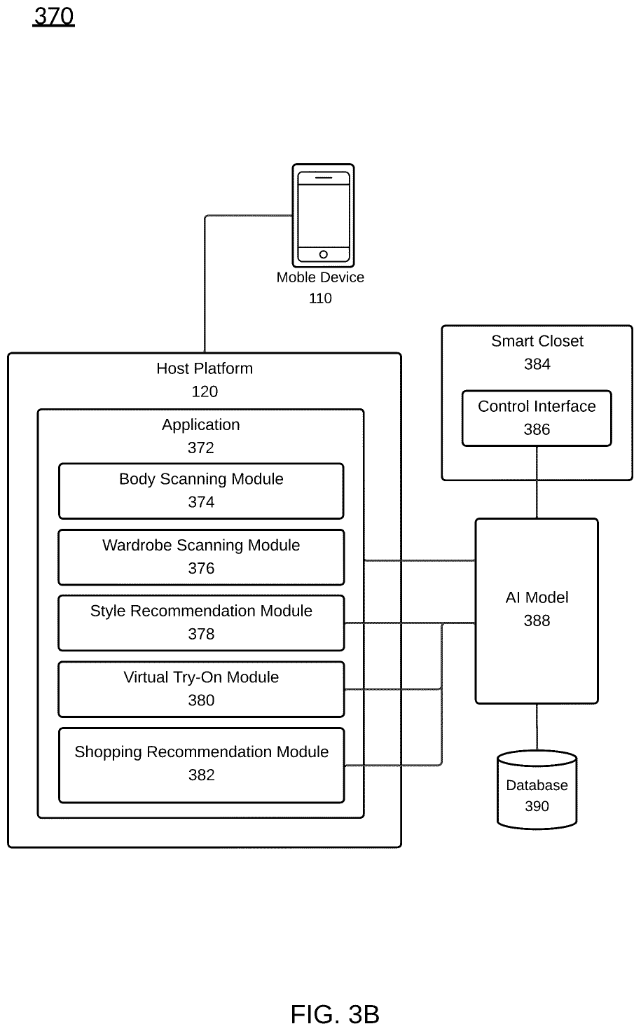

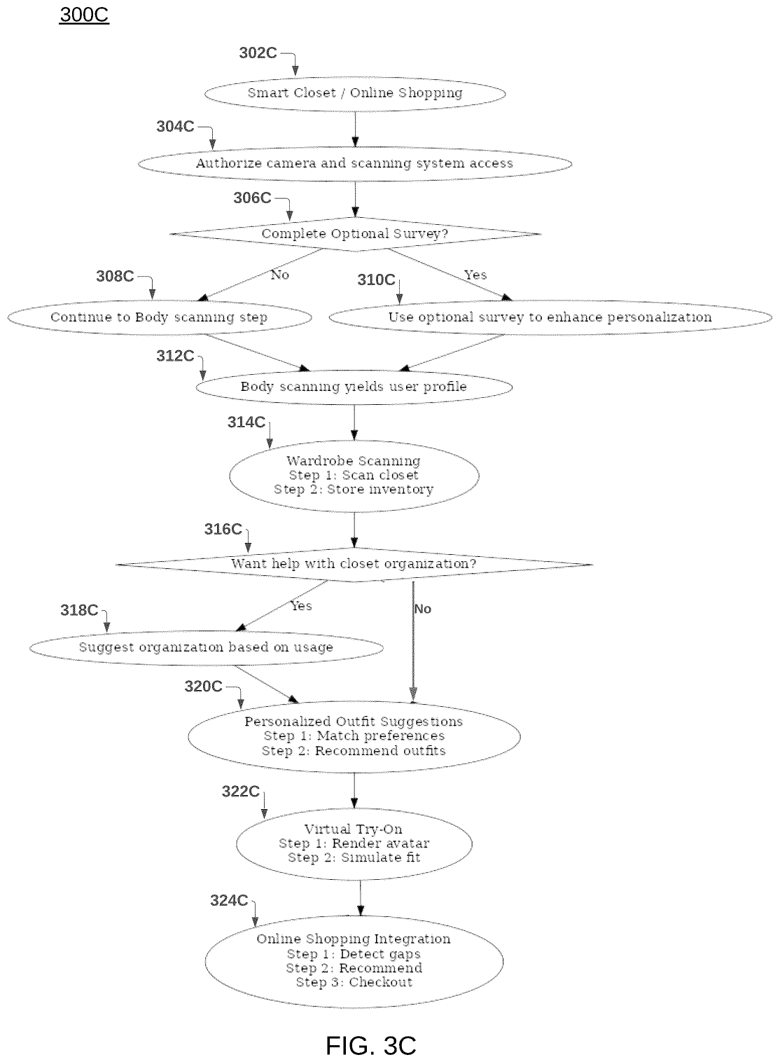

FIG. 3A illustrates a system diagram 300 that depicts an operating environment for the virtual stylist service that provides virtual try-on, personalized outfit recommendations, and wardrobe-based shopping integration, according to examples and features of the instant solution. As shown, the system includes a computing device 110 executing a software application 310. The software application 310 includes a dashboard 312 that enables interaction between the user and the virtual stylist features, including media upload, survey input, viewing outfits, and confirming purchases.

The software application 310 communicates with a host platform 120 over a network. The host platform 120 includes a testing service 340 that orchestrates communication between components and ensures that prompts generated from user interactions are processed appropriately. Within the testing service 340, a prompting subsystem 342 manages prompt dispatching logic and user-context analysis. Prompts are generated by a component labeled generate prompts 344, which outputs requests to the AI systems based on triggers from user data and wardrobe context.

The host platform 120 is communicatively coupled to various datasets including prompt data 360, response data 362, and testing data 371, which may include historical user preferences, fit results, survey responses, and product catalog metadata. These data stores interact with both the prompting subsystem 342 and the AI production system 230 to support intelligent, context- aware decision making. The system also accesses historical prompt data 350 and historical response data 352 to improve recommendation accuracy and support AI retraining cycles.

The AI production system 230 hosts a prompt generator AI model 332 and maintains feedback data 334, which is continuously updated based on user interaction with recommendations, outfits, and try-on results. The prompt generator AI model 332 serves as the core model to infer stylistic matches, predict size or fit anomalies, and simulate personalization logic. These components communicate with an AI development system 240, which facilitates model lifecycle management, including training, evaluation, and deployment, and is coupled to an AI model registry 260 that stores validated model instances.

Data collected from the software application 310 on computing device 110 is transformed into structured feature sets prior to use by the AI model 332. This transformation may include normalization of body measurements, contextual tagging of wardrobe metadata, and enrichment using historical interaction logs. The transformed feature data is utilized by the prompt generator AI model 332 to generate inference results, including outfit recommendations, virtual try-on predictions, or purchasing prompts. These responses are routed back through the prompting subsystem 342 to the dashboard 312 for user presentation. To ensure user privacy and compliance with data governance standards, the system may employ client-side data anonymization and end-to-end encryption during transmission across the network. Feedback captured through user interaction with the dashboard 312 is stored in feedback data 334 and may be aggregated and forwarded to the AI development system 240 for periodic model performance review and retraining. This feedback loop enables dynamic improvement of styling logic and ensures relevance to evolving user behavior and wardrobe changes.

FIG. 3B illustrates an operating environment for a virtual stylist 370 configured to execute on a distributed computing platform and interact with user-facing devices and AI backend services. The system is designed to receive user input, process multimedia and wardrobe data, and deliver personalized fashion recommendations and visualizations. Application 372 may execute on a cloud-hosted host platform 120 (FIG. 3A), a mobile device 110, or a hybrid of both, with front-end services rendered through a dedicated software application or browser-accessible interface. All data exchange between client and server components may occur over secure communication channels ensuring both data integrity and user privacy.

The body scanning module 374 is configured to receive sequential image frames or video captured via the camera of mobile device 110. The module initiates a scanning sequence by instructing the user, through the app UI, to perform a slow 360-degree rotation in front of the device. Each frame is subjected to image preprocessing (e.g., noise reduction, exposure normalization), and then analyzed using computer vision algorithms to detect anatomical landmarks including shoulders, elbows, hips, and knees. A 3D mesh is constructed using triangulated surface reconstruction techniques and further refined using a neural network trained on a large dataset of human body shapes to interpolate missing regions and ensure anatomical plausibility. The resultant 3D model is stored in database 390 and passed to downstream modules for virtual try-on and stylistic analysis.

The mesh construction process transforms the anatomical key points and depth data into a continuous, three-dimensional surface representation of the user's body. This process begins by ingesting the fused key point map and corresponding depth map into a surface reconstruction module, which employs triangulated surface generation to connect adjacent points based on local geometric proximity and depth continuity. An initial mesh topology is generated by constructing vertices at each spatial coordinate derived from the depth data and forming edges between vertex pairs that exhibit consistent depth gradients and anatomical adjacency.

Once the initial triangulated mesh is formed, the system applies Laplacian smoothing to reduce surface noise caused by minor inaccuracies in depth measurement. This smoothing step preserves curvature and local volume while attenuating surface irregularities. To address incomplete regions or occluded body zones, a completion module extrapolates missing mesh sections using a statistical body model trained on a corpus of full-body scans. The system parameterizes the partial mesh onto a low-dimensional shape space defined by this model and reconstructs plausible geometry in regions where input data is sparse or missing.

Texture mapping is then applied to the completed mesh. High-resolution RGB data captured during the scanning phase is processed to extract surface texture patterns, which are projected onto the mesh using UV unwrapping algorithms. The texture coordinates are generated by flattening the mesh topology and aligning the 2D imagery with corresponding surface regions, ensuring that fabric patterns, skin tones, and body features are visually coherent and photorealistic. To maintain realism under lighting variations, the system generates surface normals per vertex and stores reflectance parameters for use during rendering.

The completed mesh, with fully resolved geometry and texture, is validated by a consistency module that checks for non-manifold edges, mesh holes, and geometric self- intersections. Any errors are repaired using a constraint-based correction algorithm that prioritizes anatomical plausibility and mesh watertightness. The output is a high-resolution, anatomically accurate 3D body model that serves as the foundational structure for virtual try-on simulations, personalized garment fitting, and subsequent style analysis within the broader system architecture.

The machine learning-based model refinement process enhances the anatomical fidelity and surface accuracy of the initially generated 3D mesh by correcting structural anomalies and adapting the geometry to reflect realistic human body shapes. This refinement phase begins by extracting a feature vector from the raw mesh, which includes local curvature descriptors, joint angle approximations, surface roughness metrics, and body proportion ratios (e.g., torso-to-leg length, waist-to-hip ratio). These features are input into a pre-trained neural network model configured to output vertex displacement vectors that optimize mesh topology.

The neural network used for refinement is a graph convolutional network (GCN) specifically trained on a dataset of labeled human body scans representing a diverse population of body types, postures, and clothing conditions. Each node in the mesh graph corresponds to a vertex on the 3D model, and each edge represents a topological connection. The GCN applies message passing across these nodes, enabling the network to learn localized geometric adjustments that preserve global anatomical coherence. For instance, if the raw mesh underestimates shoulder width due to visual occlusion during scanning, the model identifies this discrepancy by comparing statistical priors with the extracted feature vector and issues vertex- level corrections accordingly.

To maintain alignment with the user's actual appearance, the refinement process is constrained by the originally detected key points. The model introduces a multi-objective loss function during inference, which penalizes deviation from the fixed anatomical landmarks while maximizing similarity to the training body shape manifold. This ensures that corrections are both realistic and personalized. The refinement also incorporates symmetry constraints across the sagittal plane of the body, ensuring that bilateral features such as arms or legs are balanced in cases where partial occlusion may have skewed the original scan.

Once the displacement vectors are computed, they are applied to the existing mesh using a weighted deformation algorithm. The algorithm ensures that vertex updates propagate smoothly across adjacent surfaces, minimizing artifacts such as vertex snapping or mesh tearing. The refined mesh is then re-evaluated for watertightness, intersection errors, and anatomical realism. This refinement stage significantly increases the quality of the mesh for downstream applications such as cloth simulation, fit prediction, and personalized stylistic analysis, and is an essential step in transforming noisy scan data into a production-grade 3D body model.

The user verification and manual adjustment process enables the user to inspect and refine the generated 3D body model to ensure that it accurately represents their physical appearance. This process is initiated once the system has completed the initial mesh generation and machine learning-based refinement stages. The resulting 3D model is rendered in a viewport within the user interface, allowing for full rotation, zoom, and pan controls to facilitate a thorough visual inspection from multiple perspectives.

To support quantitative verification, the system overlays reference markers on anatomical landmarks such as the shoulders, waist, hips, knees, and ankles. These markers correspond to the key points extracted during the body scanning process. Adjacent to each marker, the system displays corresponding body measurements (e.g., chest circumference, inseam length) that are computed from the mesh geometry. Users are prompted to compare these displayed dimensions against their known measurements or physical expectations.

If discrepancies are identified, the user may initiate the manual adjustment mode, which activates a set of precision manipulation tools. These tools include slider-based and direct manipulation controls that allow the user to expand or contract specific body regions such as the chest, arms, waist, thighs, or calves. Each manipulation is translated into a local mesh deformation using a constrained shape adjustment algorithm that preserves mesh topology and prevents geometric distortion. The deformation process is governed by vertex-weighted transformation fields that maintain the surface continuity of adjacent regions and enforce anatomical realism.

To maintain calibration consistency, any user-initiated adjustments are validated against the original key point framework and depth map. Adjustments are constrained to remain within a statistical envelope defined by body shape priors to avoid unrealistic deformations. As adjustments are made, the system dynamically updates measurement readouts and re-renders the affected body regions to reflect changes in real time.

Upon user confirmation, the adjusted mesh is saved as the canonical body model and is committed to the user profile for subsequent use in garment fitting, virtual try-on, and style recommendation processes. A versioning system retains the original mesh and all user modifications, enabling rollback or comparison in future sessions.

Database 390 functions as the central repository for all system data generated or required across the modules in FIG. 3A. For example, the body scanning module 374 captures biometric data, including body measurements and shape profiles, which are stored in Database 390 for long-term reference. This ensures that the avatar generated for try-on and the size prediction algorithms have consistent, accurate foundational data.

Similarly, the wardrobe scanning module 376 extracts visual and categorical metadata from the smart closet inventory, identifying garment types, styles, usage frequency, and positional context (e.g., which shelf or section a garment is stored on). This scanned wardrobe inventory is indexed and archived in Database 390, enabling the system to track garment history, generate reminders for underused items, and infer clothing lifecycle trends.

The style recommendation module 378 relies on Database 390 to retrieve and update the user's stylistic profile, which includes prior feedback on recommended outfits, selection patterns, contextual metadata (e.g., seasonality, events, weather), and preference weights across fabrics, colors, or cuts. These data are used by the AI model 388 to compute real-time recommendations, which are recorded back into the database with associated feedback and session metadata to continuously train the system.

The virtual try-on module 380 uses stored avatar parameters, previously rendered garments, and simulation calibration data from Database 390 to display accurate, personalized outfit visuals. Interaction events during try-on, such as garment layering, swap-outs, camera angle focus, and dismissals, are also logged into the database. This behavioral telemetry allows the system to refine how try-ons are prioritized or styled in future sessions.

The system captures a continuous video stream or a sequence of still images as the user performs a guided rotational movement to ensure full 360-degree coverage of the body. Throughout this capture process, the system applies stabilization algorithms to correct for hand jitter, minor shifts in posture, and inconsistencies in movement speed. Frame-by-frame analysis is conducted to detect and correct motion blur or optical distortion, preserving the geometric integrity of the captured data. By compensating for camera and user movement artifacts in real time, the system ensures that each frame contributes to a cohesive and accurate visual dataset, which is critical for precise anatomical reconstruction and depth estimation in the subsequent modeling stages.

The shopping recommendation module 382 uses wardrobe gap analysis derived from inventory data, user behavior, and interaction logs (all from Database 390) to propose missing or complementary items. If the user proceeds with a purchase, the transaction metadata, product details, sizes, purchase channels, and return outcomes, is also recorded, further enriching the recommendation and customization pipeline.

The wardrobe scanning module 376 is configured to digitize the user's existing clothing inventory. It allows clothing items to be added via functionality, such as: (1) scanning manufacturer barcodes using the device camera and decoding them via a barcode parser; (2) scanning embedded RFID tags via a near-field communication (NFC) module or an RFID scanner embedded in a smart closet 384; or (3) manually entering metadata including brand, color, material, and type through the application UI. For visual identification, the module supports image capture of each item, applies background removal using image segmentation models, and stores cropped images for texture and silhouette reference. Clothing metadata may be structured in JSON and stored in database 390, indexed by item ID, wardrobe slot, and last- worn timestamp.

The style recommendation module 378 is responsible for generating context-aware outfit suggestions. It retrieves body shape descriptors from body scanning module 374, user interaction logs (e.g., likes, saves, skips), and historical clothing selections from database 390. The module tokenizes survey responses and user-provided textual inputs using natural language processing (NLP) methods. Collaborative filtering is performed using a matrix factorization model trained on anonymized wardrobe and preference data across multiple users, while content-based filtering uses a decision-tree or cosine similarity engine that matches item attributes (e.g., fit, color, brand) to the user's known preferences. Inference requests are routed through a prompting subsystem 342 (FIG. 3A), which formats inputs into model-ready embeddings and queries the AI model 388, also referenced in FIG. 3A as AI model 332. Outputs from the model include a ranked list of garments, suggested outfit combinations, and event-specific attire recommendations. These are serialized and returned to the UI through an API gateway, where the user may view, accept, or customize the recommendations.

The virtual try-on module 380 generates a real-time rendering of selected clothing items on the user's 3D model. For items not yet owned by the user, the system retrieves 3D garment models from integrated retail APIs in standard formats. For owned items, garment silhouettes and textures are estimated using image-to-3D reconstruction methods such as GAN-based models trained to infer depth and drape from 2D images. The clothing models are fitted to the body mesh using rigging and skinning techniques, and simulation of fabric dynamics is performed using a physics engine. Lighting effects are enhanced through shader programs written in GLSL or HLSL that simulate fabric reflectance and ambient occlusion. The rendered try-on is displayed at 30-60 frames per second (FPS) on compatible GPUs or in rasterized snapshots on lower-end devices. Fit feedback is calculated by comparing cloth-body proximity maps and is used to highlight tight or loose zones with color overlays. The results are returned to the application UI and also logged in response data 362 and feedback data 334 (FIG. 3A) for downstream model tuning.

During key point detection, the system receives the stabilized image sequence or video and processes each frame using a computer vision module that executes a convolutional neural network trained to identify anatomical landmarks. These landmarks include, but are not limited to, the shoulders, elbows, hips, knees, and facial reference points. Each detected key point is assigned a coordinate in two-dimensional space relative to the camera frame, and confidence scores are computed for each detection to filter unreliable points. Temporal coherence is enforced by tracking these key points across multiple frames using optical flow estimation and bounding box re-identification, ensuring spatial continuity of the anatomical layout. The final output of this stage is a high-fidelity key point map that encapsulates the geometric structure of the user's body across the capture sequence.

Following key point detection, the system proceeds to perform depth mapping. The depth mapping module integrates multi-view geometry techniques to estimate the distance from the camera to each region of the body surface. Stereo depth is calculated by triangulating matched visual features across sequential frames that capture the subject from slightly shifted angles due to their rotation. For cases where stereo disparity is insufficient due to low texture regions or occlusion, the system invokes a depth completion algorithm based on a secondary neural network trained to infer missing depth values from structural cues and learned priors. The resulting depth map assigns a depth value to each pixel or surface point, forming a dense spatial representation of the user's body. This depth information is then fused with the 2D key point layout to create a partial 3D structure, which is later refined during mesh construction.

The shopping recommendation module 382 functions as a commerce decision engine. It connects to external retail platforms via OAuth-secured APIs and performs catalog synchronization. Garment metadata is cached locally and filtered against the user's preferences, wardrobe gaps, seasonal trends, and past purchase history. The module leverages event detection from the user's calendar or prompts (e.g., “need an outfit for a wedding”) to recommend context- relevant items. Inventory availability, size compatibility, and estimated delivery dates are verified through real-time stock queries. Recommendations are returned to the UI, where the user can initiate try-on previews, add items to a wish list, or proceed to checkout via a redirected session with the vendor's store.

The system integrates a smart closet 384, which may be a physical furniture unit embedded with sensors, microcontrollers, barcode or RFID readers, and a touch or LED-based control interface 386. This hardware interface allows the user to scan items physically, view outfit suggestions, or receive location guidance for items stored within. The control interface is synchronized with the cloud-based database and receives push notifications of daily outfit suggestions or maintenance alerts (e.g., “last worn 60 days ago”).

Each of the modules in application 372 exchanges structured messages, routed via HTTPS or message queues. Modules are orchestrated using a microservices framework, allowing independent scaling of rendering, inference, and database services. AI model 388 is hosted in the AI production system 230 (FIG. 3A) and trained via the AI development system 240 using historical prompt-response pairs, interaction logs, and labeled feedback. All learning artifacts are versioned and managed via model registry 260. User data is encrypted at rest and in transit, and privacy controls allow granular sharing and deletion of personal styling information.

The wardrobe scanning module 376 captures garments stored within the smart closet 384 by establishing a communication channel through the control interface 386. This control interface queries embedded RFID tags, garment ID markers, or inventory logs within the smart closet and transmits garment identification and location data to the wardrobe scanning module. Upon receiving the data, the module processes garment metadata, including brand, color, usage count, and category, by tagging and structuring the entries. The wardrobe scanning module then writes these entries to the database 390 via the AI model 388, which acts as an intermediary for structured garment ingestion. The AI model 388 periodically queries the wardrobe dataset to compute wear frequency and trend metrics, allowing it to classify items as underused when their usage falls below a predefined threshold over a time window. Once identified, the style recommendation module 378 initiates a contextual rule evaluation using event history, seasonal alignment, and style compatibility (all accessible from the database 390) to determine whether a garment is suitable for repurposing, donation, or resale. The output of this decision process is forwarded to the mobile device 110, where the application 372 renders annotated overlays showing indicators such as “List for Resale” or “Consider Donating,” localized over the corresponding garment in the AR view.

The detection and management of repetition patterns is performed by the AI model 388, which analyzes historical wear data collected by the wardrobe scanning module 376 and stored in the database 390. This includes timestamps, event metadata, weather conditions, and contextual labels such as “worn at social gathering” or “worn during presentation.” When a user selects an outfit via the mobile device 110, the AI model compares the selected garment identifiers against past usage logs. If the garments match or strongly resemble items worn during similar events or with overlapping attendees, the style recommendation module 378 flags the overlap as a potential repetition. The system further computes a “repetition relevance score” that accounts for time elapsed, event importance, and user-specific sensitivity to outfit redundancy. This score is used to determine whether to surface an AR prompt via the display of the application 372 on the mobile device, warning the user of the repetition and optionally suggesting alternate items with similar aesthetic or fit characteristics through the virtual try-on module 380. This proactive approach to avoiding outfit redundancy reinforces the system's function as an intelligent wardrobe advisor.

The body scanning module 374 functions by receiving continuous data streams from sensors on the mobile device 110, such as depth sensors, facial detection cameras, or LiDAR. It extracts body measurements and transient features, like hair position or posture, using a dimensional pose-estimation pipeline. These parameters are packaged and sent to the AI model 388, which adjusts garment relevance scores based on rule sets derived from the style recommendation module 378. For example, when the body scanning module detects that the user's hair is positioned in an upward configuration, the AI model increases selection priority for tops and dresses from the wardrobe database that feature neckline embellishments or shoulder- centric designs. The updated style ranking is returned to the style recommendation module, which in turn updates the visual styling cues presented on the mobile device.

The virtual try-on module 380 interfaces with both the body scanning module 374 and the style recommendation module 378 to provide real-time visualization of selected outfits. Upon activation, it retrieves 3D body mesh data and anthropometric inputs from the body scanning module and matches those against garment dimension tags stored in the database 390. Using rendering templates and draping models managed by the try-on module, it simulates fabric deformation and alignment based on body topology. Behavioral inputs, such as smiles, frowns, head tilts, or swipe gestures, are captured by the mobile device and transmitted to the control interface 386, where they are interpreted into command structures. The control interface translates a smile into an “accept” signal, a frown into “dismiss,” and a swipe into “cycle next.” These command signals are then forwarded to the virtual try-on module to adjust the visual state accordingly, enabling a touchless and responsive AR fitting experience.

The shopping recommendation module 382 accesses both the structured output of the wardrobe scanning module 376 and the current user measurements from the body scanning module 374 to infer missing wardrobe components or synergistic styling gaps. The AI model 388 cross-references available wardrobe categories and user style patterns against trend and availability data in the database 390 to generate purchasing suggestions. These recommendations are transmitted to the mobile device 110, where the application 372 renders real-time AR overlays next to existing wardrobe items, visually showing complementary clothing options sourced from partnered vendors. The module dynamically adapts suggestions based on the latest scanned outfit and body parameters, allowing for context-aware fashion augmentation.

The application modules 372, including modules 374 through 382, interoperate with the AI model 388, smart closet 384, control interface 386, and database 390 to create a self-updating, context-driven clothing selection engine. The instant solution cycles between wardrobe scanning, body scanning, recommendation, and try-on feedback, adapting outputs with each new user gesture or input, and delivering a personalized, real-time fashion interface via the mobile device 110.

Accessory preferences are managed through coordinated interaction between the body scanning module 374, the style recommendation module 378, and the AI model 388. The body scanning module 374 captures real-time image data from the mobile device 110, including facial region analysis and detection of accessory types such as earrings, necklaces, eyewear, and headbands. This visual data is processed to identify accessory presence, category, and approximate size or color features. The AI model 388 maps these detected accessories to associated style vectors stored in the database 390, where historical co-wear patterns and user- specified preferences are maintained. For example, if the user is detected to be wearing bold earrings, the style recommendation module 378 adjusts garment ranking rules to de-prioritize busy necklines or collar embellishments and favor more minimalist top styles. Conversely, if no accessories are detected, the system may elevate more visually complex garment options. These adjustments are presented dynamically through the mobile device 110, allowing the user to view optimized styling recommendations in the virtual try-on module 380, with accessory-aware combinations rendered in the AR preview. This integration ensures that the outfit curation process remains visually balanced and aligned with the user's active accessory choices.

FIG. 3C illustrates a flow 390 for a user experience through a virtual stylist service, as implemented by the application shown in FIGS. 3A and 3B. The figure outlines the key functional stages encountered by a user from initialization to completion of virtual try-on and shopping interaction. The process begins at block 302C, where the user launches a mobile or web-based application associated with either a smart closet system or a partner e-commerce platform. The application verifies user credentials and retrieves a personalized style profile and wardrobe inventory from database 390. In an initial configuration, if no style profile exists, the system may prompt the user to create one through a brief onboarding flow.

At block 304C, the system requests access to the device camera and guides the user through camera setup. This step may include functionality, such as position calibration, lighting optimization, and framing guidance, etc. The application may use computer vision to detect user presence and assess capture quality in real time. If image quality falls below a preset threshold (e.g., due to low light or excessive motion blur), the system may halt progression and request correction, thereby ensuring reliable body scanning and model generation. Once authorized, the system proceeds to block 306C, where the user is optionally prompted to complete a style preference survey. The survey captures data points including favored aesthetics (e.g., “chic,” “streetwear”), typical use cases (e.g., formal, casual), color preferences, and preferred brands. These data are preprocessed and embedded for input into AI model 388 (FIG. 3B) for personalized recommendations.

Block 308C initiates the body scanning procedure, where the user is instructed to perform a guided 360-degree rotation while the device camera captures a sequence of images or a short video. The system may apply functionality, such as motion stabilization, multi-view reconstruction, and key point detection to construct a full 3D mesh of the user's body. If the user does not complete a full 360-degree rotation, or if occlusions are detected (e.g., arms covering torso), the system may return an error or prompt the user to retry, addressing a limitation that incomplete scans may degrade model accuracy. In a successful capture, the model is validated for completeness and stored.

In parallel or as a subsequent step, block 310C enables the wardrobe scanning operation, which may involve automatic RFID or barcode scanning from a smart closet 384 (FIG. 3B), or manual item entry through the mobile interface. The system associates items with slots in a virtual wardrobe and syncs to cloud storage. Limitations addressed here include the potential lack of RFID tags on older garments, requiring manual data entry or visual item matching. The system is designed to be resilient in such cases by allowing users to upload clothing photos for image classification, though it notes this process may reduce metadata precision.

At block 312C, users are optionally prompted to reorganize their wardrobe. The smart closet system provides recommendations on folding versus hanging, seasonal rotation, and location-based suggestions based on usage frequency and item type. The system uses historical wear data and user-defined priorities to propose this organization; however, physical constraints such as limited closet space may restrict the realization of some recommendations. This limitation is mitigated by providing ranked options based on priority (e.g., preserving high-use or high-value items in most accessible locations).

Block 320C involves the generation of personalized outfit suggestions. The system calls style recommendation module 378 (FIG. 3B), which processes current body shape, wardrobe availability, and historical style data to select optimal combinations. The AI model provides garment pairings and contextual labels (e.g., “work-ready,” “weekend look”). The system may reject combinations that do not meet fit or aesthetic thresholds; for example, if the AI determines that a selected top is incompatible in fit or style with a skirt in the inventory, it will exclude that suggestion. Users are shown top-ranked options, with alternatives presented based on availability or occasion flexibility.

At block 322C, the system invokes the virtual try-on module, using the previously generated 3D body model and rendered garments. This module simulates fabric physics and visual fidelity in real time or near real time depending on device capabilities. Users may rotate the model, switch garments, or view pressure-mapped fit overlays. Limitations at this stage include potential visual artifacts on older devices without GPU acceleration and minor inaccuracies when fabric behavior models are extrapolated from single images of user-uploaded wardrobe items. The system attempts to mitigate such limitations by using fallback simulation modes (static pose renders) when full simulation is not supported.

At block 324C, the user transitions to a shopping experience. If the user has selected new clothing items not already in the wardrobe, the shopping recommendation module 382 (FIG. 3B) retrieves retail metadata including stock status, delivery times, and discount eligibility. The system checks for size compatibility by comparing garment specifications with the user's scanned body measurements. Incompatible items are flagged or removed from the recommendation list. The user may proceed to an in-app checkout or be redirected to the external vendor's site via secure API tokens.

A custom items creation process represents a tailored extension of the smart closet ecosystem that dynamically transitions the user from passive clothing suggestions to active wardrobe enhancement. This stage is triggered after a virtual try-on session, during which the system may detect gaps in the user's wardrobe, such as the absence of well-fitting garments in specific categories (e.g., formal attire, seasonal wear, or athletic gear). These gaps are not only determined through explicit user input but also inferred from the user's preferences, prior outfit selections, and behavioral engagement with the virtual closet.

Upon identifying a need, the system initiates a workflow for custom garment creation. This begins with a match between the user's body scan data and idealized garment templates. The AI engine, trained on historical tailoring outcomes, digital fitting data, and fabric behavior models, suggests garment types that would most benefit from customization. For example, if the scan indicates an atypical waist-to-hip ratio or asymmetrical posture, the system proposes tailored pants or jackets, linking this insight to prior dissatisfaction recorded during try-on feedback loops.

To facilitate the creation of these custom garments, the system engages with third-party tailoring or digital fabrication platforms through pre-integrated APIs. It transmits the user's scanned dimensions, style preferences, and selected fabrics, which the user may preview or modify within the interface. In an alternative embodiment, this transmission can occur autonomously. For example, the system could initiate a smart-ordering protocol that generates a draft custom item and notifies the user with an opt-in confirmation for fulfillment. The generated item can then be delivered to the user's address with optional features such as remote fitting validation (via follow-up scan) and post-delivery satisfaction tracking.

A user interaction logging stage introduces a behavioral intelligence layer to the smart closet and virtual try-on ecosystem. This functionality operates after the user has engaged with personalized outfit suggestions and simulated clothing fit on their digital avatar. At this point, the system begins capturing granular details of how the user interacts with the recommended garments, including selection frequency, duration of engagement with specific outfits, try-on repetition patterns, abandonment points, and navigation behavior within the wardrobe interface.

These interaction signals are collected in a non-intrusive manner, leveraging event tracking protocols that monitor clicks, scroll depth, zoom level on garments, and switching behavior between items. For example, if a user frequently rotates the avatar while viewing a jacket but ultimately skips purchasing or saving the item, the system records this as high curiosity but low conversion, triggering a re-ranking of similar products in future sessions. These insights are further enriched by temporal patterns, such as the time of day or contextual events (e.g., holidays, weather) that correlate with different styles being explored.

The captured interaction data is then used to refine the underlying recommendation algorithms. In a user-triggered embodiment, the user may explicitly rate garments or tag items with likes, dislikes, or comments, all of which are appended to their preference profile. Alternatively, in an autonomous embodiment, the system uses machine learning models trained on aggregated user behavior datasets to classify implicit signals into categories such as high interest, moderate indecision, or negative response. These classifications feed back into the AI model, adjusting styling predictions, closet organization, and even fit simulation parameters for better alignment with user expectations.

An interaction logging functionality forms the foundation for long-term personalization. Over time, the system can recognize evolving style preferences, shifts in body measurements, or seasonal wear patterns, allowing it to dynamically adapt recommendations. It also supports proactive suggestions such as reminders for underused items, nudge prompts for forgotten combinations, or predictions for high-retention purchases.

In another example of the instant solution, the final stage integrates both user interaction tracking and shopping integration, forming a comprehensive dual-path extension that enhances both personalization and commerce within the smart closet ecosystem. After the user completes the virtual try-on experience, the system concurrently activates two branches. The first captures behavioral feedback, while the second links the user's preferences and fit history to available commercial inventory, enabling dynamic product discovery and procurement.

On the interaction side, the system logs how users engage with outfits, tracking selection behavior, time spent viewing specific garments, and revisit frequency. Behavioral analysis is applied to identify patterns such as indecisiveness, frequent comparison loops, or consistent preferences for certain silhouettes or colors. In one embodiment, users may explicitly annotate garments with satisfaction ratings or comments, which the system uses to retrain its styling engine. In an alternative embodiment, these signals are inferred autonomously using heuristics and AI models trained on aggregate user data, enabling the system to adapt styling logic, avatar rendering fidelity, and closet organization based on inferred sentiment and intent.

The shopping integration pathway leverages data from the interaction and try-on sessions to generate contextual purchase recommendations. The system detects unmet wardrobe needs, such as lack of outerwear, redundancy in color palettes, or seasonal gaps, and presents curated shopping options. These suggestions are matched against the user's size profile and stylistic inclinations and are sourced from integrated retail platforms or brand partners. In a dynamic embodiment, the system can pre-select cart items and initiate checkout flows on behalf of the user, pending approval, thereby minimizing friction between interest and acquisition. It can also dynamically adjust its suggestions based on inventory availability, user budget constraints, and return behavior history.

The system captures a continuous video stream or a sequence of still images as the user performs a guided rotational movement to ensure full 360-degree coverage of the body. Throughout this capture process, the system applies stabilization algorithms to correct for hand jitter, minor shifts in posture, and inconsistencies in movement speed. Frame-by-frame analysis is conducted to detect and correct motion blur or optical distortion, preserving the geometric integrity of the captured data. By compensating for camera and user movement artifacts in real time, the system ensures that each frame contributes to a cohesive and accurate visual dataset, which is critical for precise anatomical reconstruction and depth estimation in the subsequent modeling stages.

By executing both pathways in parallel, the system ensures a closed-loop feedback mechanism where behavior not only informs style evolution but also activates relevant commerce opportunities. This configuration allows the smart closet to serve both as a personalized fashion assistant and as a context-aware shopping gateway, capable of anticipating user needs and delivering high-fit, low-effort wardrobe solutions.

The smart closet platform introduces a sophisticated combination of emotional engagement analysis and custom item creation, forming a deeply personalized extension of the user journey. This dual-stage logic is initiated after the virtual try-on and styling recommendation phases, where the system begins evaluating the user's emotional response to viewed or tried-on garments. The emotional analysis is based on non-verbal cues, primarily captured through facial expression recognition and sentiment estimation algorithms that operate via the device's camera.

The instant solution includes a non-contact purchase confirmation mechanism that interprets user input through facial expressions, gestures, or voice commands. During the virtual try-on session, the system continuously monitors the user via the device's camera and microphone to detect predefined engagement signals. For facial expressions, the system utilizes a facial landmark detection algorithm that identifies micro-expressions such as smiles, raised eyebrows, or nods. These expressions are mapped to specific confirmation intents; for example, a sustained smile may indicate approval of the selected outfit. Similarly, gesture recognition is enabled through skeletal tracking and motion analysis, where gestures like a thumbs-up or swipe- to-confirm are interpreted as approval signals. These actions are analyzed in real time using computer vision and pose estimation models and are linked to contextual UI states to avoid misinterpretation.

For voice-based confirmation, the system incorporates a lightweight natural language understanding (NLU) engine that processes spoken commands captured through the device's built-in microphone. Users may issue verbal confirmations such as “I'll take this,” “Add to closet,” or “Buy now,” which are parsed and matched against an intent dictionary. The NLU engine accounts for synonyms, tonal cues, and context to disambiguate user intent. To ensure transaction security and user intent clarity, the system may prompt for a secondary confirmation (e.g., a voice-verified PIN or repeated phrase) if ambiguity is detected. All input modalities are processed within the local device or through encrypted cloud inference services, ensuring privacy and responsiveness.

An emotional engagement functionality executing in the application 372 uses computer vision models trained on annotated datasets of facial landmarks and affective states. These models map micro-expressions such as smiles, frowns, eyebrow raises, or gaze aversion to discrete emotional categories like satisfaction, confusion, or disappointment. For example, if a user frequently exhibits signs of visual engagement but shows no signs of joy or approval, the system may interpret this as a mismatch between aesthetic interest and perceived fit or comfort. In an alternative embodiment, this emotional mapping occurs dynamically and silently, adjusting the recommendation engine's weights in real-time to de-emphasize garments eliciting negative sentiment without requiring any direct user feedback.

Building upon this emotional intelligence layer, the system then transitions into a custom item creation workflow when it detects a persistent unmet emotional response across multiple try-on sessions. The rationale is that standard retail inventory may be insufficient to satisfy the user's nuanced preferences or unique fit requirements. Using the user's scanned body profile, emotional preference vector, and previously expressed style leanings, the system generates a proposed custom item. This proposal includes garment type, fabric selection, and fit parameters optimized to elicit a more positive emotional reaction.

The platform integrates directly with digital tailoring services or on-demand manufacturing pipelines. It sends the complete garment specification, including aesthetic targets derived from emotional data, and receives back a design draft, which can be rendered on the user's avatar for confirmation. If approved, the system finalizes the garment for fabrication and delivery. Over time, the emotional feedback from both virtual previews and real-world usage is reintroduced into the AI training pipeline, enabling the system to refine not just fit but also the affective impact of garment suggestions.

A simplified feedback loop is introduced that feeds directly into AI model refinement. This structure distills the smart closet experience into its most essential cycle: try-on, evaluate, and adapt. After the user engages with the virtual try-on interface, selecting items, viewing fit simulations, and navigating style suggestions, the system captures immediate response data and behavioral traces to assess the quality of the experience. This includes which items were selected, which were discarded, and which combinations led to the most sustained engagement or were added to a shortlist.

This embodiment avoids branching into external shopping flows, custom tailoring services, or mood interpretation. Instead, the focus is entirely on learning from user engagement signals to update the AI model's internal understanding of the user's taste and fit preferences. The collected feedback may include explicit inputs such as star ratings or favorites, but more commonly relies on implicit indicators like browsing time, interaction density with garment details, and repeat viewing patterns. These signals are used to fine-tune the system's recommendation logic, retrain predictive models, and adjust how garments are rendered and styled on the avatar.

The system processes this feedback continuously in the background. After each session, it updates the user's stylistic profile and body model, refining future suggestions without requiring the user to retrain or reconfigure settings. For example, if the system observes that a user consistently abandons items with structured shoulders or prefers darker tones, it will deprioritize those features in subsequent recommendations. Over time, this adaptive mechanism ensures that the virtual try-on experience becomes increasingly aligned with the user's preferences, even as those preferences evolve.

This feedback-centric configuration prioritizes system responsiveness and long-term personalization over one-off actions like purchases or tailoring. It is ideal for lightweight deployments where user input must be unobtrusive, yet the system still seeks to deliver high relevance and satisfaction. The feedback loop reinforces a user-centric AI lifecycle, ensuring that each interaction incrementally improves the system's accuracy, efficiency, and style intuition.

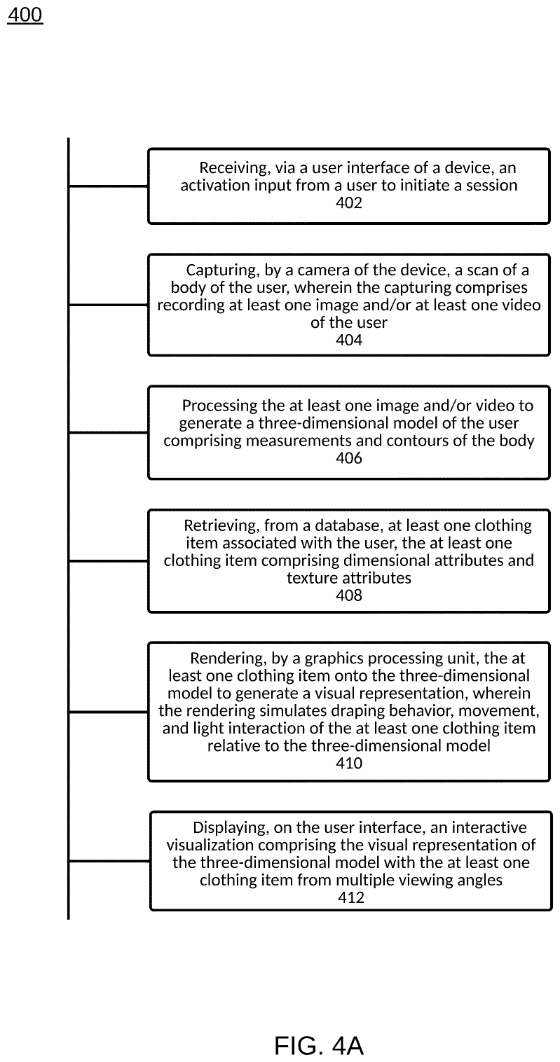

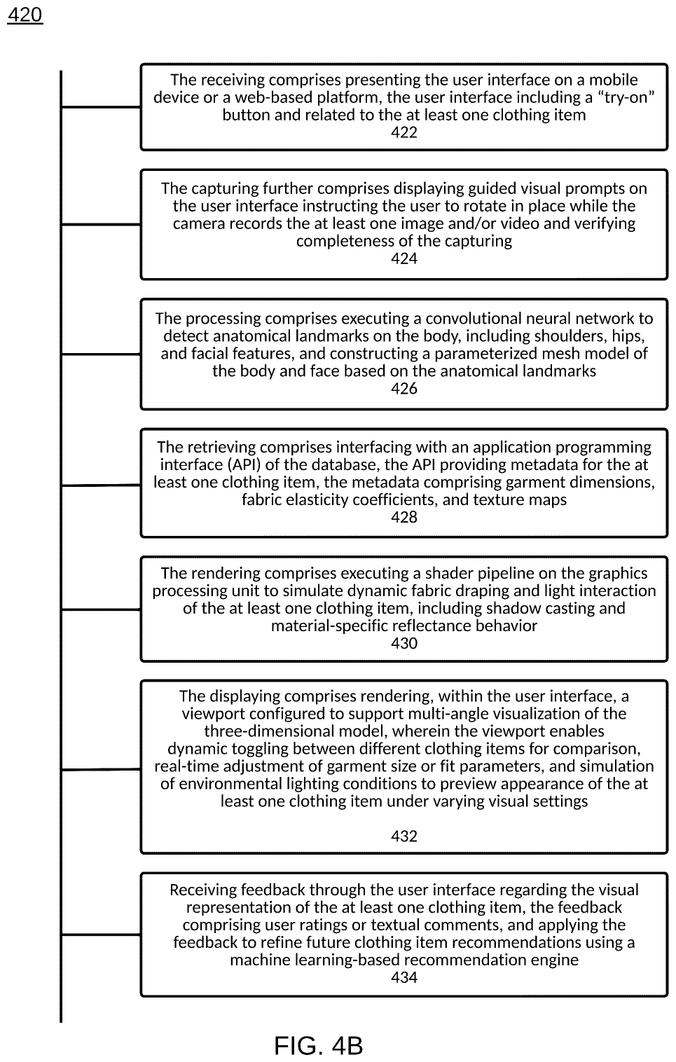

FIG. 4A illustrates an example of a method 400A for a virtual stylist according to examples and features of the instant solution. As an example, the method 400A may be performed by a computing system, a software application, a server, a cloud platform, a combination of systems, and the like. Referring to FIG. 4A, in 401A, the method may include receiving, via a user interface of a device, an activation input from a user to initiate a session. In 404, the method may include capturing, by a camera of the device, a scan of a body of the user, wherein the capturing comprises recording at least one image and/or at least one video of the user. In 406, the method may include processing the at least one image and/or video to generate a three-dimensional model of the user comprising measurements and contours of the body. In 408, the method may include. In 408, the method may include retrieving, from a database, at least one clothing item associated with the user, the at least one clothing item comprising dimensional attributes and texture attributes. In 410, the method may include rendering, by a graphics processing unit, the at least one clothing item onto the three-dimensional model to generate a visual representation, wherein the rendering simulates draping behavior, movement, and light interaction of the at least one clothing item relative to the three-dimensional model. In 412, the method may include displaying, on the user interface, an interactive visualization comprising the visual representation of the three-dimensional model with the at least one clothing item from multiple viewing angles.

FIG. 4B illustrates a method 400B for a virtual stylist according to other examples and features of the instant solution. As an example, the method 400B may be performed by a computing system, a software application, a server, a cloud platform, a combination of systems, and the like. Referring to FIG. 4B, in 422, the method may include the receiving comprising presenting the user interface on a mobile device or a web-based platform, the user interface including a “try-on” button and related to the at least one clothing item. In 424, the method may include the capturing comprising displaying guided visual prompts on the user interface instructing the user to rotate in place while the camera records the at least one image and/or video and verifying completeness of the capturing. In 426, the method may include the processing comprising executing a convolutional neural network to detect anatomical landmarks on the body, including shoulders, hips, and facial features, and constructing a parameterized mesh model of the body and face based on the anatomical landmarks. In 428, the method may include the retrieving comprising interfacing with an application programming interface (API) of the database, the API providing metadata for the at least one clothing item, the metadata comprising garment dimensions, fabric elasticity coefficients, and texture maps. In 430, the method may include the rendering comprising executing a shader pipeline on the graphics processing unit to simulate dynamic fabric draping and light interaction of the at least one clothing item, including shadow casting and material-specific reflectance behavior. In 432, the method may include the displaying comprises rendering, within the user interface, a viewport configured to support multi-angle visualization of the three-dimensional model, wherein the viewport enables dynamic toggling between different clothing items for comparison, real-time adjustment of garment size or fit parameters, and simulation of environmental lighting conditions to preview appearance of the at least one clothing item under varying visual settings. In 434, the method may include receiving feedback through the user interface regarding the visual representation of the at least one clothing item, the feedback comprising user ratings or textual comments, and applying the feedback to refine future clothing item recommendations using a machine learning-based recommendation engine.

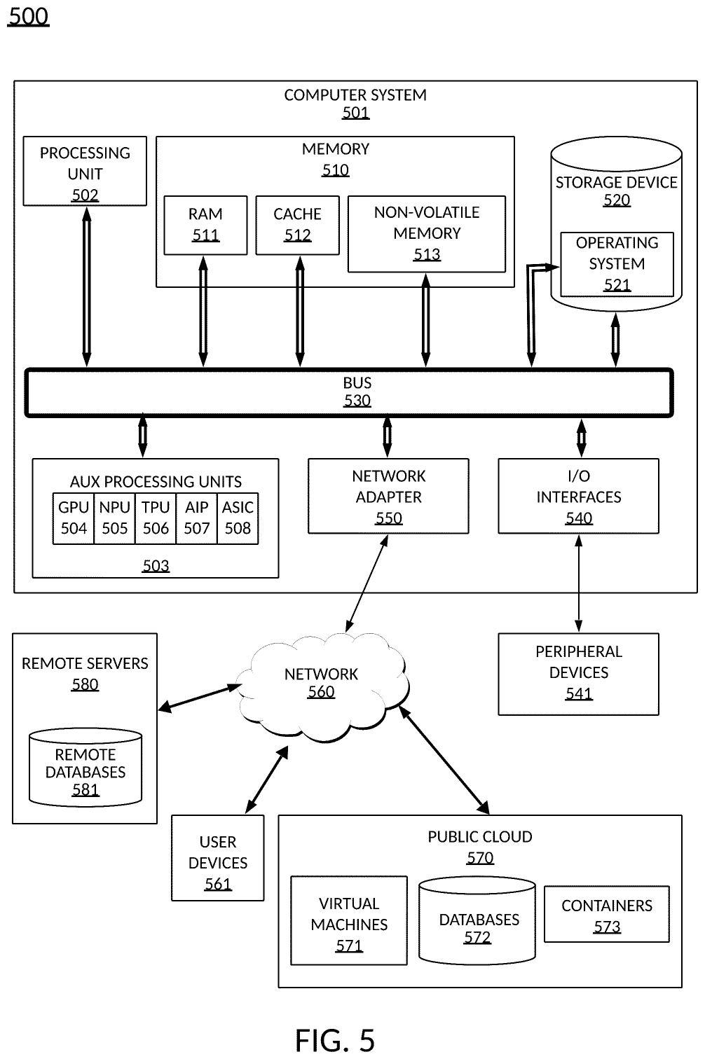

The examples and features of the instant solution may be implemented in at least one of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer- implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain at least one Graphics Processing Unit (GPU) 504, Neural Processing Unit (NPU) 505, Tensor Processing Unit (TPU) 506, AI Processor (AIP) 507, or other Application Specific Integrated Circuit (ASIC) 508. The at least one APU 503 may contain circuitry distributed over multiple integrated circuit chips. Each APU 503 may implement multiple processor threads and multiple processor cores. Each APU 503 may include at least one of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, at least one of the at least one APU 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non- volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing device. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de- packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for example, comprise at least one physical or logical block of computer instructions that may, for example, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for example, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. A method, comprising:
receiving, via a user interface of a device, an activation input from a user to initiate a session;
capturing, by a camera of the device, a scan of a body of the user, wherein the capturing comprises recording at least one image and/or at least one video of the user;
processing the at least one image and/or video to generate a three-dimensional model of the user comprising measurements and contours of the body;
retrieving, from a database, at least one clothing item associated with the user, the at least one clothing item comprising dimensional attributes and texture attributes;
rendering, by a graphics processing unit, the at least one clothing item onto the three- dimensional model to generate a visual representation, wherein the rendering simulates draping behavior, movement, and light interaction of the at least one clothing item relative to the three- dimensional model; and
displaying, on the user interface, an interactive visualization comprising the visual representation of the three-dimensional model with the at least one clothing item from multiple viewing angles.

2. The method of claim 1, wherein the receiving comprises presenting the user interface on a mobile device or a web-based platform, the user interface including a “try-on” button and related to the at least one clothing item.

3. The method of claim 1, wherein the capturing further comprises displaying guided visual prompts on the user interface instructing the user to rotate in place while the camera records the at least one image and/or video and verifying completeness of the capturing.

4. The method of claim 1, wherein the processing comprises executing a convolutional neural network to detect anatomical landmarks on the body, including shoulders, hips, and facial features, and constructing a parameterized mesh model of the body and face based on the anatomical landmarks.

5. The method of claim 1, wherein the retrieving comprises interfacing with an application programming interface (API) of the database, the API providing metadata for the at least one clothing item, the metadata comprising garment dimensions, fabric elasticity coefficients, and texture maps.

6. The method of claim 1, wherein the rendering comprises executing a shader pipeline on the graphics processing unit to simulate dynamic fabric draping and light interaction of the at least one clothing item, including shadow casting and material-specific reflectance behavior.

7. The method of claim 1, wherein the displaying comprises rendering, within the user interface, a viewport configured to support multi-angle visualization of the three-dimensional model, wherein the viewport enables at least one of:
dynamic toggling between different clothing items for comparison;
real-time adjustment of garment size or fit parameters; and
simulation of environmental lighting conditions to preview appearance of the at least one clothing item under varying visual settings.

8. The method of claim 1, further comprising receiving feedback through the user interface regarding the visual representation of the at least one clothing item, the feedback comprising user ratings or textual comments, and applying the feedback to refine future clothing item recommendations using a machine learning-based recommendation engine.

9. A system, comprising:
a computing device comprising a processor, a memory, a display, and a camera;
a user interface, executable on the computing device and configured to receive an activation input from a user to initiate a session;
a body scanning module, executable on the processor and configured to capture, via the camera, at least one image and/or at least one video of a body of the user and to generate a three- dimensional model of the user based on the at least one image and/or video, the three-dimensional model comprising measurements and contours of the body;
a clothing retrieval module, configured to retrieve at least one clothing item associated with the user from a database, the at least one clothing item comprising dimensional attributes and texture attributes; and
a rendering engine, comprising a graphics processing unit (GPU) configured to render the at least one clothing item onto the three-dimensional model to generate a visual representation simulating draping behavior, movement, and light interaction;
wherein the user interface is further configured to display an interactive visualization comprising the visual representation of the three-dimensional model with the at least one clothing item from multiple viewing angles.

10. The system of claim 9, wherein the user interface is configured for execution on a mobile device or web-based platform and comprises a “try-on” button associated with the at least one clothing item.

11. The system of claim 9, wherein the body scanning module is further configured to display guided prompts instructing the user to rotate in place during the capture of the at least one image and/or video, and to verify completion of a full 360-degree scan.

12. The system of claim 9, wherein the body scanning module comprises a convolutional neural network configured to detect landmarks including shoulders, hips, and facial features, and to generate a parameterized mesh model based on the landmarks.

13. The system of claim 9, wherein the clothing retrieval module communicates with a remote database via an application programming interface (API), the API being configured to provide garment metadata including dimensions, fabric elasticity coefficients, and texture maps.

14. The system of claim 9, wherein the rendering engine is configured to execute a shader pipeline to simulate physics-based fabric draping and realistic light interaction, including shadow generation and material-specific reflectance.

15. The system of claim 9, wherein the user interface includes a viewport for visualizing the three- dimensional model and supports at least one of:
dynamic toggling between clothing items;
real-time garment fit adjustment; and
simulation of lighting conditions to preview an appearance of garments under different environments.

16. The system of claim 9, further comprising a feedback module configured to receive feedback comprising user ratings or textual comments through the user interface regarding the visual representation, and to update a recommendation engine using the feedback to improve future garment suggestions via machine learning.

17. A computer-readable storage medium comprising instructions which when executed by a processor cause the processor to perform:
receiving, via a user interface of a device, an activation input from a user to initiate a session;
capturing, by a camera of the device, a scan of a body of the user, wherein the capturing comprises recording at least one image and/or at least one video of the user;
processing the at least one image and/or video to generate a three-dimensional model of the user comprising measurements and contours of the body;
retrieving, from a database, at least one clothing item associated with the user, the at least one clothing item comprising dimensional attributes and texture attributes;
rendering, by a graphics processing unit, the at least one clothing item onto the three- dimensional model to generate a visual representation, wherein the rendering simulates draping behavior, movement, and light interaction of the at least one clothing item relative to the three- dimensional model; and
displaying, on the user interface, an interactive visualization comprising the visual representation of the three-dimensional model with the at least one clothing item from multiple viewing angles.

18. The computer-readable storage medium of claim 17, wherein the receiving comprises presenting the user interface on a mobile device or a web-based platform, the user interface including a “try-on” button and related to the at least one clothing item.

19. The computer-readable storage medium of claim 17, wherein the capturing further comprises displaying guided prompts on the user interface instructing the user to rotate in place while the camera records the at least one image and/or video and verifying completeness of the capturing.

20. The computer-readable storage medium of claim 17, wherein the processing comprises executing a convolutional neural network to detect anatomical landmarks on the body, including shoulders, hips, and facial features, and constructing a parameterized mesh model of the body and face based on the anatomical landmarks.
